(19) United States
(12) Patent Application Publication
(10) Pub. No.: US 2005/0010464 A1
(43) Pub. Date: Jan. 13, 2005

(54) Method of and apparatus for managing meeting, and computer product

(75) Inventors: Hideyuki Okuno, Kawasaki (JP); Hiroshi Oki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/785,131

(22) Filed: Feb. 25, 2004

(30) Foreign Application Priority Data
Jul. 11, 2003 (JP) 2003-195733

(51) Int. Cl. G06F 17/60

(52) U.S. Cl. 705/8

(57) ABSTRACT

An apparatus for managing meeting information on meetings received from client terminals via a network includes a meeting manager that manages, upon receipt of the meeting information on meetings from the client terminals, the meetings based on meeting registration information including the meeting information registered with associated meeting identification codes.

### BACKGROUND OF THE INVENTION

1) Field of the Invention

The present invention relates to a method of, an apparatus for, and a computer product for managing meetings.

2) Description of the Related Art

A meeting management apparatus known in the art stores pieces of meeting information, which is information on meetings, when the pieces of meeting information are received from client terminals via a network. This meeting management apparatus operates a meeting support system such as a meeting room reservation system based on the meeting information on meetings, including at least one of a meeting title, an attendee name, a meeting date, and a meeting location.

For example, Japanese Patent Application Laid-open No. H6-187531 discloses a conventional art for calculating a meeting cost per attendee in a meeting held in a specific meeting room using entrance/exit information to/from a meeting room and attendee identification codes. Japanese Patent Application Laid-open No. 2002-197236 discloses a conventional art for accumulating meeting record data per attendee using a non-contact reader/writer to create meeting record data per attendee.

The conventional art disclosed in Japanese Patent Application Laid-open No. H6-187531 can calculate the meeting cost per attendee in the meeting held in the specific meeting room using entrance/exit information to/from the meeting room and attendee identification codes; however, cannot systematically manage meeting costs by person, meeting, and organization. The conventional art disclosed in Japanese Patent Application Laid-open No. 2002-197236 can accumulate meeting record data per attendee using the non-contact reader/writer to create meeting record data per attendee; however, cannot systematically manage schedule by person, meeting, and organization.

### SUMMARY OF THE INVENTION

It is an object of the present invention to solve the problems in the conventional technology.

An apparatus for managing meeting information on meetings received from client terminals via a network, according to one aspect of the present invention, includes a meeting manager that manages, upon receipt of the meeting information on meetings from the client terminals, the meetings based on meeting registration information including the meeting information registered with associated meeting identification codes.

A method of managing meeting information on meetings received from client terminals via a network, according to another aspect of the present invention, includes managing, upon receipt of the meeting information on meetings from the client terminals, the meetings based on meeting registration information including the meeting information registered with associated meeting identification codes.

A computer program according to still another aspect of the present invention realizes the method according to the above aspect on a computer.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is to explain an a concept of a meeting management system according to a first embodiment of the present invention;

FIG. 2 is an example of meeting management data extracted from a meeting database;

FIG. 3 is a functional block diagram of the meeting management system;

FIG. 4 is an example of meeting registration information stored in the meeting database;

FIG. 5 is an example of attendee identification information stored in the meeting database;

FIG. 6 is an example of classes and unit prices per time in the attendee identification information;

FIG. 7 is an example of expense management numbers and job names in the attendee identification information;

FIG. 8 is an example of meeting record data stored in the meeting database;

FIG. 9 is an example of display of a meeting cost calculated by a meeting cost calculator;

FIG. 10 is an example of the meeting cost by person;

FIG. 11 is an example of the meeting cost by meeting;

FIG. 12 is an example of the meeting cost by project;

FIG. 13 is a flowchart of meeting management process performed by the meeting management system;

FIG. 14 is a flowchart of meeting room reservation process performed by the meeting management system;

FIG. 15 is a flowchart of attendee schedule management process performed by the meeting management system;

FIG. 16 is a flowchart of meeting notification process performed by the meeting management system;

FIG. 17 is a flowchart of meeting minute management process performed by the meeting management system;

FIG. 18 is a schematic of a computer system according to a second embodiment of the present invention; and

FIG. 19 is a block diagram of a main unit in the computer system.

### DETAILED DESCRIPTION

Exemplary embodiments of a method of, an apparatus for, and a computer product for managing meetings according to the present invention are explained below with reference to the accompanying drawings. In these embodiments the meeting management apparatus according to the present invention is applied, although not limited, to a meeting management system.

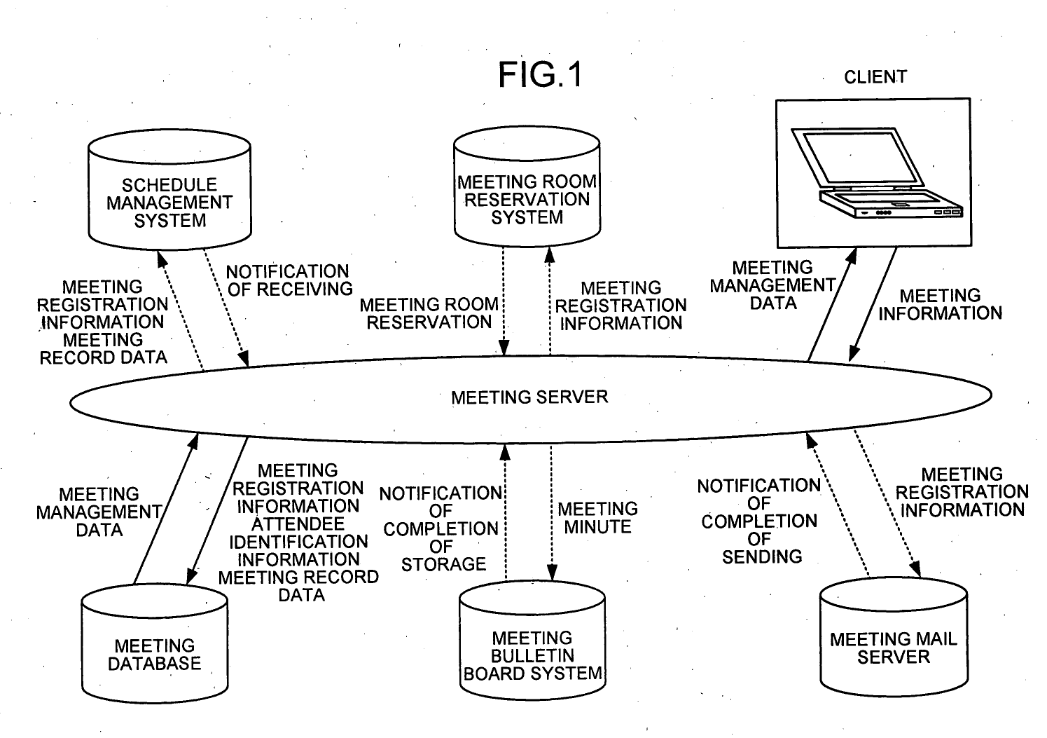

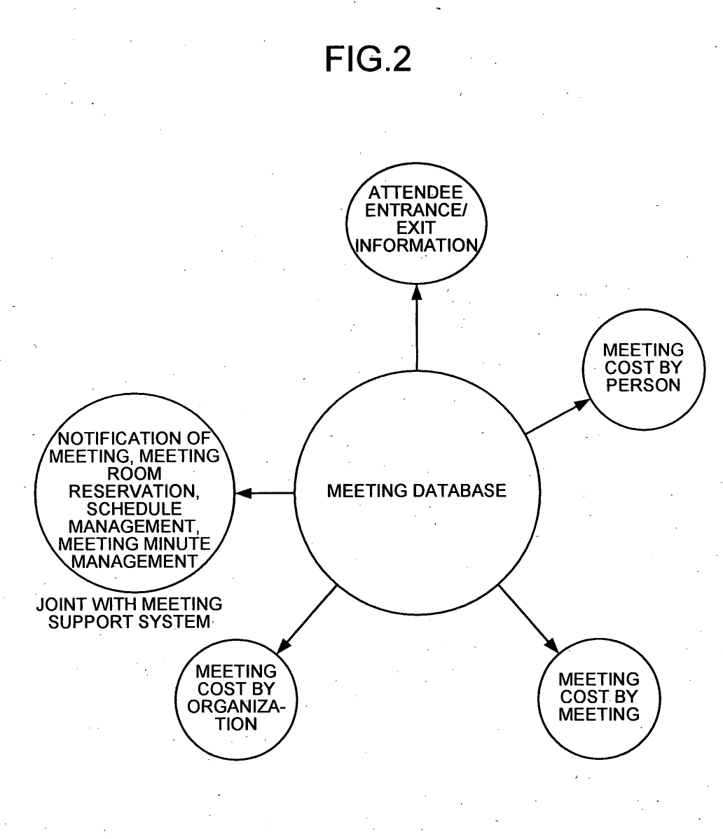

The concept of the meeting management system according to a first embodiment is explained first. FIG. 1 is to explain the concept of the meeting management system according to the first embodiment. FIG. 2 is an example of meeting management data extracted from a meeting database illustrated in FIG. 1.

As illustrated in FIG. 1, the meeting management system includes a server-client system that includes a meeting server and a client. When the meeting server receives meeting information from the client, including a title of, a date of, and attendees to a meeting, it manages the meeting based on meeting registration information including the meeting information registered with an associated meeting identification code. The meeting server includes a meeting database that contains meeting registration information, attendee identification information, meeting record data and so forth. The meeting server extracts the meeting management data from the meeting database. The meeting server manages other meeting support systems such as a meeting mail server, a meeting room reservation system, a schedule management system, and a meeting bulletin board system.

As illustrated in FIG. 2, the meeting server calculates meeting costs by person, meeting, and organization from data in the meeting database. Moreover, the meeting server extracts entrance/exit information including the identification information and entrance/exit times about the attendee from the meeting database for entrance/exit management of the attendee.

The meeting server sends (see FIG. 1) the meeting registration information to the meeting room reservation system so that the meeting room reservation system is managed to reserve a meeting room based on the meeting registration information. The meeting server produces a meeting guidance based on the meeting reservation information and manages the meeting mail server such that it notifies the meeting guidance of the meeting attendees. The meeting server sends the meeting registration information and meeting record data to the schedule management system so that the schedule management system is managed to display schedules of the attendees based on the meeting registration information. The meeting server stores the meeting record data and manages the schedule management system such that it reads out the meeting record data and produces a monthly report on the attendee, if required. The meeting server sends the meeting minutes to the meeting bulletin board system so that the meeting bulletin board system is managed to store the meeting minutes.

Briefly, the meeting management apparatus includes the meeting server that manages the meeting information on the meetings received from the clients via the network to systematically manage the meetings registered with associated meeting identification codes.

Specifically, the meeting management apparatus includes the meeting server that, on receipt of the meeting information on meetings from the client terminals, manages the meetings based on the meeting registration information including the meeting information registered with associated meeting identification codes. Therefore, it is possible to systematically manage the meetings registered with associated meeting identification codes.

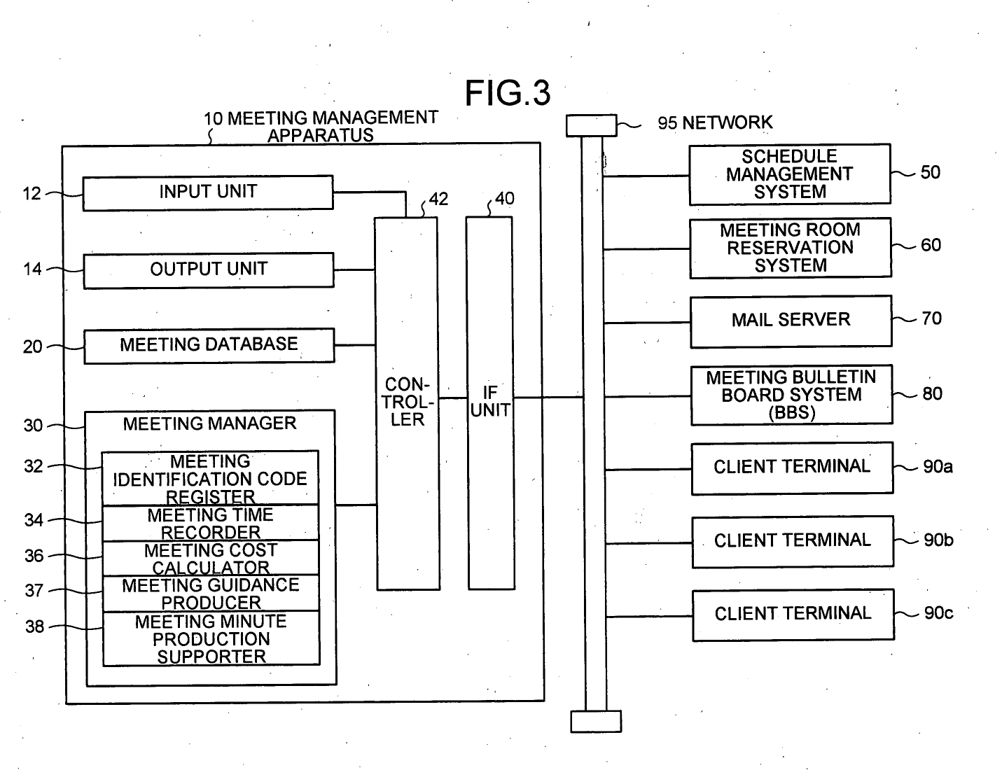

Configuration of the meeting management system according to the first embodiment is explained next. FIG. 3 is a functional block diagram of the meeting management system. The meeting management system includes a meeting management apparatus 10, a schedule management system 50, a meeting room reservation system 60, a mail server 70, a meeting bulletin board system (BBS) 80, client terminals 90a, 90b, and 90c, and a network 95.

The schedule management system 50 manages a personal schedule. Specifically, the schedule management system 50 makes reservations or registrations of the personal schedule and displaying and managing the schedule. The meeting room reservation system 60 selects a meeting room based on the meeting registration information and reserves the meeting room with an associated meeting identification code. The mail server 70 relays an e-mail based on a protocol such as Simple Mail Transfer Protocol (SMTP) and Post Office Protocol (POP) when the e-mail is transmitted and received over the Internet.

The meeting bulletin board system 80 stores and displays minutes of the meetings with associated meeting identification codes. The client terminals 90a, 90b, and 90c are terminals for communicating data such as the meeting information with the meeting management apparatus 10 based on the hyper text transport protocol (HTTP) via the network 95.

The meeting management apparatus 10 includes an input unit 12, an output unit 14, a meeting database 20, a meeting manager 30, an interface (IF) unit 40, and a controller 42. The input unit 12 is an apparatus for entering an instruction or request and data from a user. Specifically, the input unit 12 is a keyboard, a mouse, or a touch pen. The output unit 14 is an apparatus for providing the status and data of the meeting management apparatus 10. Specifically, the output unit 12 is a printer, or an image display device such as a cathode ray tube (CRT) and a liquid crystal display (LCD).

The meeting database 20 includes the meeting registration information, the attendee identification information, and the meeting record data. The meeting registration information contains the meeting title associated with the meeting identification code, the attendee name and identification code, the meeting date, and the meeting room. The attendee identification information contains the attendee name and identification code, and the identification information about the attendee. The meeting record data contains the attendee name and identification code associated with the meeting identification code, and attendee entrance/exit times.

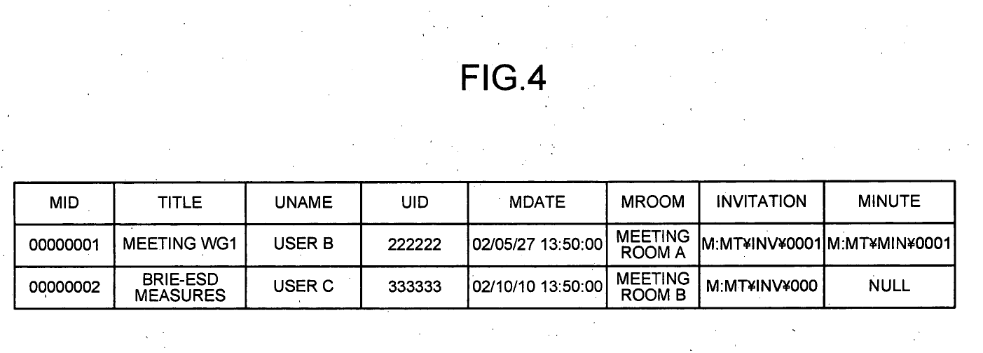

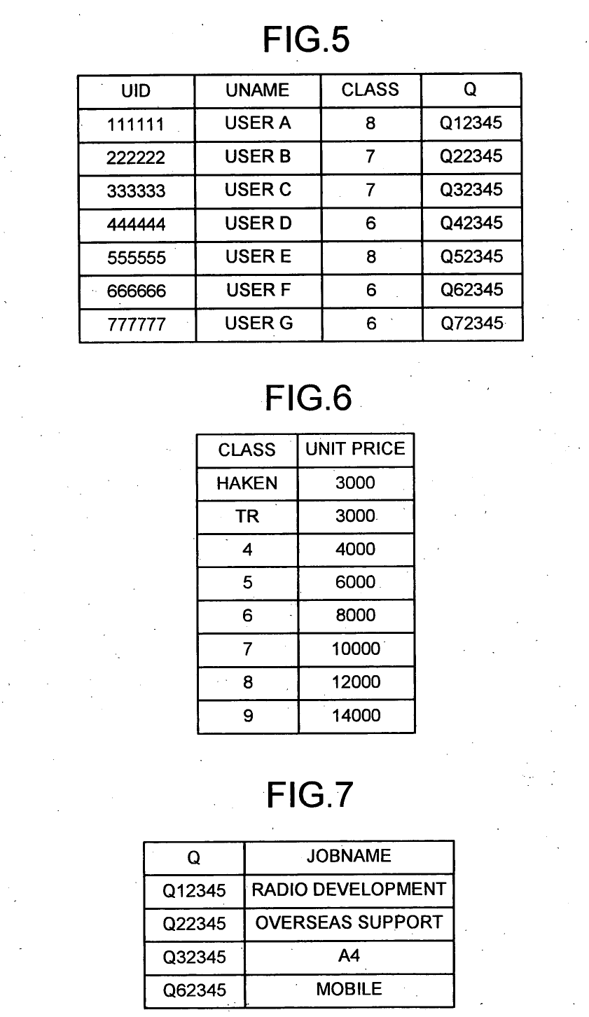

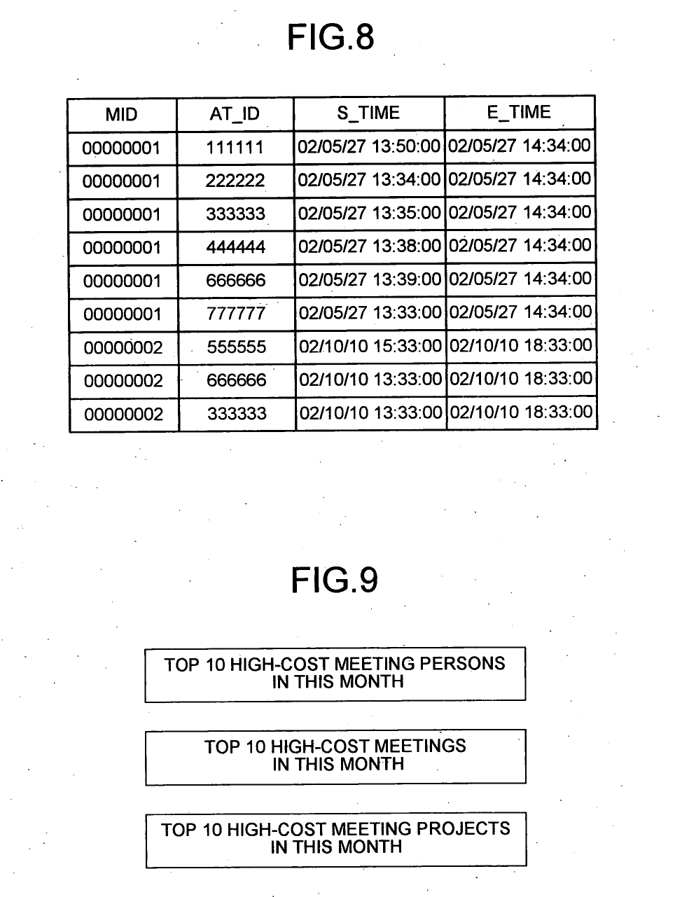

Contents of the meeting database 20 will now be explained in detail. FIG. 4 illustrates an example of meeting registration information stored in the meeting database 20. FIG. 5 illustrates an example of attendee identification information stored in the meeting database 20. FIG. 6 illustrates an example of classes and unit prices per time in the attendee identification information. FIG. 7 illustrates an example of expense management numbers and job names in the attendee identification information. FIG. 8 illustrates an example of meeting record data stored in the meeting database 20.

As illustrated in FIG. 4, the meeting registration information includes a meeting identification code (MID), a meeting title (TITLE), a user name (UNAME), a user identification code (UID), a meeting date (MDATE), a meeting room (MROOM), a pass to a meeting-guidance holder file (INVITATION), and a pass to a meeting minute holder file (MINUTE).

As illustrated in FIG. 5, the attendee identification information includes a user identification code (UID), a user name (UNAME), a class (CLASS), and an expense management number (Q). The class (CLASS) of the attendee is associated with a unit price per time as illustrated in FIG. 6. The expense management number (Q) is associated with a job name (JOBNAME) as illustrated in FIG. 7.

As illustrated in FIG. 8, the meeting record data includes a meeting identification code (MID), an attendee identification code (AT_ID), a start time (S_TIME), and an end time (E_TIME). The meeting database 20 holds an e-mail address associated with the attendee name or the attendee identification code thought it is not illustrated. The attendee name or the attendee identification code is employed to retrieve the e-mail address when an e-mail is employed to notify of the meeting guidance.

The meeting manager 30, on receipt of the meeting information on meetings from the client terminals 90a, 90b, and 90c, manages the meetings based on meeting registration information including the meeting information registered with associated meeting identification codes. Specifically, the meeting manager 30 includes a meeting identification code register 32, a meeting time recorder 34, a meeting cost calculator 36, a meeting guidance producer 37, and a meeting minute production supporter 38.

The meeting identification code register 32 registers the meeting information associated with the meeting identification code as the meeting registration information. The meeting time recorder 34 records the identification information and entrance/exit times about the attendee associated with the meeting identification code. Specifically, the identification information and entrance/exit times about the attendee are read out of a card at a card reader connected to the client terminal 90a, 90b, and 90c located in the meeting room. They are then fed to the meeting management apparatus 10 and recorded as meeting record data in the meeting database 20.

The meeting cost calculator 36 calculates a meeting cost based on the meeting record data and the attendee identification information. The meeting record data includes the identification information and entrance/exit times about the attendee recorded at the meeting time recorder 34. The attendee identification information includes the class, the unit price per time and the project name associated with the attendee. Specifically, the meeting cost calculator calculates a meeting cost by person, a meeting cost by meeting, and a meeting cost by organization.

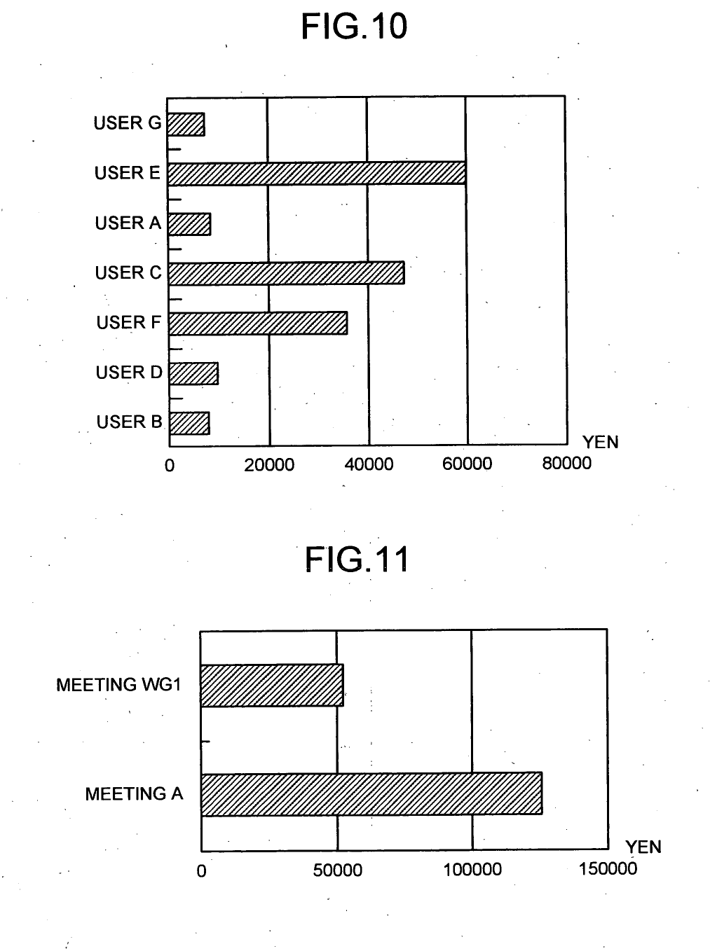

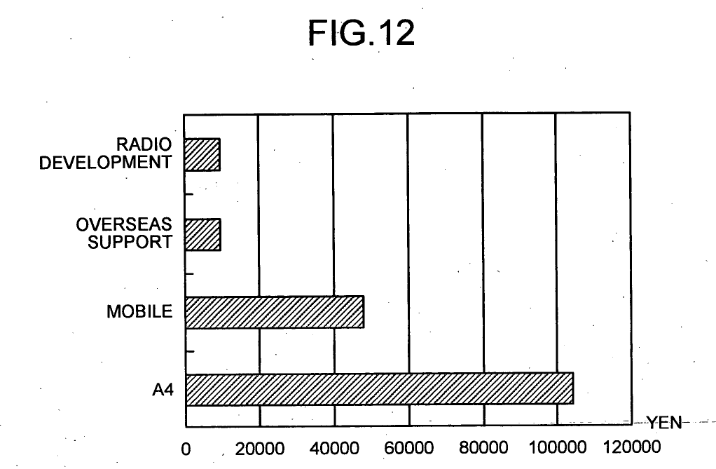

An example of display of the meeting cost, an example of the meeting cost by person, an example of the meeting cost by meeting, and an example of the meeting cost by project, calculated at the meeting cost calculator 36 are explained below. FIG. 9 illustrates an example of display of the meeting cost. FIG. 10 illustrates an example of the meeting cost by person, FIG. 11 illustrates an example of the meeting cost by meeting, and FIG. 12 illustrates an example of the meeting cost by project.

As illustrated in FIG. 9, the meeting management apparatus 10 provides and displays top 10 high-cost meetings by person, meeting, and project in the organization monthly as the meeting management data based on the meeting costs calculated at the meeting cost calculator 36. As illustrated in FIG. 10, the meeting management apparatus 10 provides and displays the meeting cost by person in the organization monthly as the meeting management data based on the meeting costs calculated at the meeting cost calculator 36. In FIG. 10, the vertical axis indicates personal names and the lateral axis indicates costs in Japanese yen (the yen may be replaced with any other currency) required for meetings.

As illustrated in FIG. 11, the meeting management apparatus 10 provides and displays the meeting cost by meeting in the organization monthly as the meeting management data based on the meeting costs calculated at the meeting cost calculator 36. In FIG. 11 the vertical axis indicates meeting names and the lateral axis indicates costs in Japanese yen (the yen may be replaced with any other currency) required for meetings. As illustrated in FIG. 12, the meeting management apparatus 10 provides and displays the meeting cost by project in the organization monthly as the meeting management data based on the meeting costs calculated at the meeting cost calculator 36. In FIG. 12 the vertical axis indicates project names and the lateral axis indicates costs in Japanese yen (the yen may be replaced with any other currency) for meetings.

The meeting guidance producer 37 produces a meeting guidance based on the meeting registration information in the meeting database 20 and notifying the attendees of the meeting guidance by e-mail. The meeting database 20 is retrieved for the e-mail addresses of the attendees. The meeting minute production supporter 38 is a processor for supporting the user to produce a meeting minute based on the meeting registration information and meeting record data in the meeting database 20 and holding the meeting minute in a file indicated in MINUTE of FIG. 4. Specifically, the meeting minute production supporter 38 creates a meeting minute template format including meeting titles, dates, locations, and attendees described based on the meeting registration information and the meeting record information to support the user to produce a meeting minute.

The IF unit 40 is a network interface for use in data communications under the HTTP protocol over the network 95 by the meeting management apparatus 10 with the schedule management system 50, the meeting reservation system 60, the mail server 70, the meeting bulletin board system 80, and the client terminals 90a, 90b, and 90c. The controller 42 is a controller for controlling the whole meeting management apparatus 10. It accepts requests and instructions from users to control data flow in each processor in the meeting management apparatus 10.

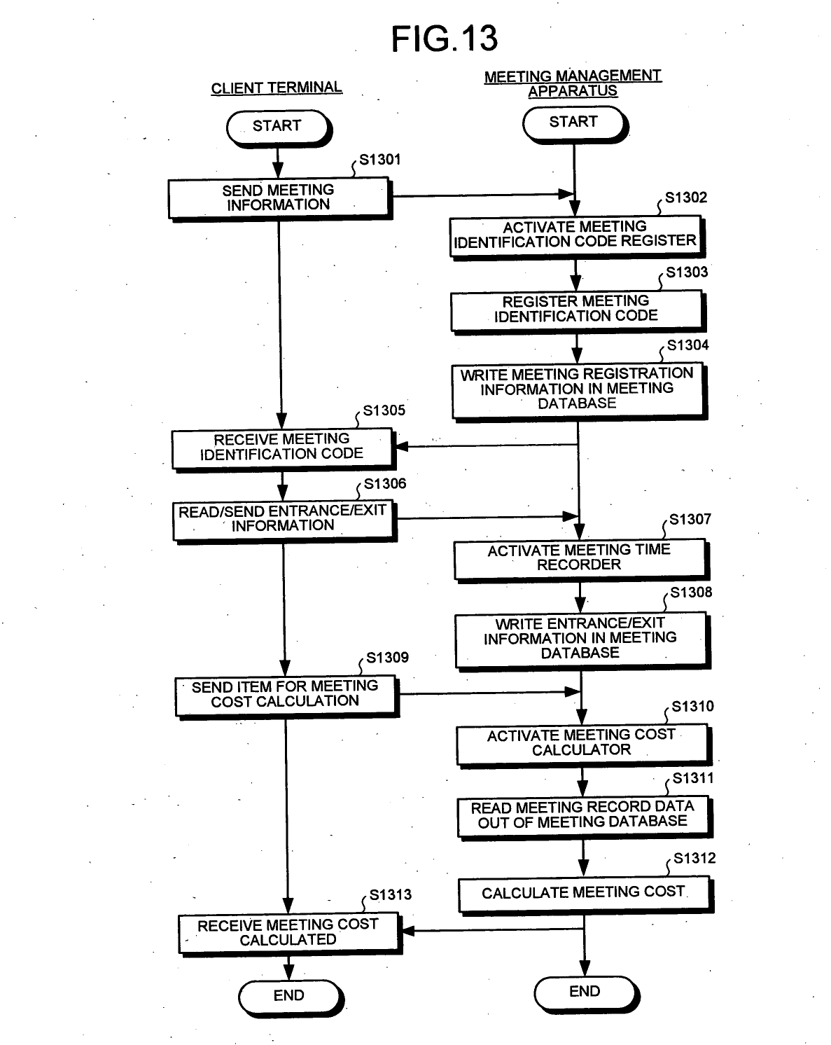

A meeting management process performed by the meeting management system is explained next while referring to the flowchart of FIG. 13. As illustrated in FIG. 13, prior to the start of a meeting, meeting information is sent from the client terminal 90a, 90b, 90c to the meeting management apparatus 10 (step S1301). When the meeting management apparatus 10 receives the meeting information from the client terminal 90a, 90b, 90c, it activates the meeting identification code register 32 (step S1302). The meeting management apparatus 10 then registers the meeting information with an associated meeting identification code as meeting registration information (step S1303), and writes the meeting registration information in the meeting database 20 (step S1304). The client terminal 90a, 90b, 90c receives the meeting identification code after the meeting information is registered as the meeting registration information (step S1305).

During the meeting, a meeting attendee inserts his/her card into a card reader located in the meeting room on entrance to and exit from the meeting room. The client terminal 90a, 90b, 90c employs the card reader to read entrance/exit information including the identification information and entrance/exit times about the attendee from the card, and sends it to the meeting management apparatus 10 (step S1306). When the meeting management apparatus 10 receives the entrance/exit information from the client terminal 90a, 90b, 90c, it activates the meeting time recorder 34 (step S1307). The meeting time recorder 34 then writes the entrance/exit information into the meeting record data in the meeting database 20 (step S1308).

After the closing of the meeting, the client terminals 90a, 90b, 90c send items for meeting cost calculation to the meeting management apparatus 10 (step S1309). When the meeting management apparatus 10 receives the items for meeting cost calculation from the client terminals 90a, 90b, 90c, it activates the meeting cost calculator 36 (step S1310). The meeting cost calculator 36 then reads the attendee identification information and the meeting record data out of the meeting database 20 (step S1311), and calculates meeting costs on the items for meeting cost calculation required from the client terminals 90a, 90b, 90c (step S1312). Thereafter, the client terminals 90a, 90b, 90c receive from the meeting management apparatus 10 (step S1313) the meeting costs calculated.

Thus, in the first embodiment, on receipt of the meeting information on meetings from the client terminals 90a, 90b, and 90c, the meetings are managed based on the meeting registration information including the meeting information registered with associated meeting identification codes. Therefore, the meeting manager 30 can systematically manage the meetings registered with associated meeting identification codes.

The meeting identification code register 32 registers the meeting information with associated meeting identification codes. Therefore, the meeting manager 30 can manage the meetings based on the meeting registration information registered with associated meeting identification codes by the meeting identification code register 32.

The meeting database 20 stores the meeting registration information including the meeting information on the meetings registered with associated meeting identification codes. Therefore, the meeting manager 30 can manage the meetings based on the meeting registration information stored in the meeting database 20.

The meeting information includes at least one of a meeting title, an attendee name, a meeting date, and a meeting location. Therefore, the meeting manager 30 can manage the meetings based on the meeting registration information stored in the meeting database 20.

The meeting time recorder 34 records the identification information and entrance/exit times about the attendees in the meetings. In addition, the meeting database 20 stores the meeting record data on the identification information and entrance/exit times about the attendees, which are recorded by the meeting time recorder 34 and associated with meeting identification codes, and stores the attendee identification information about the attendees associated with costs per unit time and assigned organizations. Therefore, the meeting manager 30 can manage the meetings based on the meeting record data and the attendee identification information stored in the meeting database 20.

The meeting cost calculator 36 calculates meeting costs based on the entrance/exit times and the costs per unit time about the attendees in the meetings. Therefore, the meeting manager 30 can manage costs of the meetings based on the meeting costs calculated by the meeting cost calculator 36.

The meeting cost calculator 36 calculates meeting costs by person, meeting and organization, respectively. Therefore, the meeting manager 30 can manage costs of the meetings systematically based on the meeting costs by person, meeting and organization.

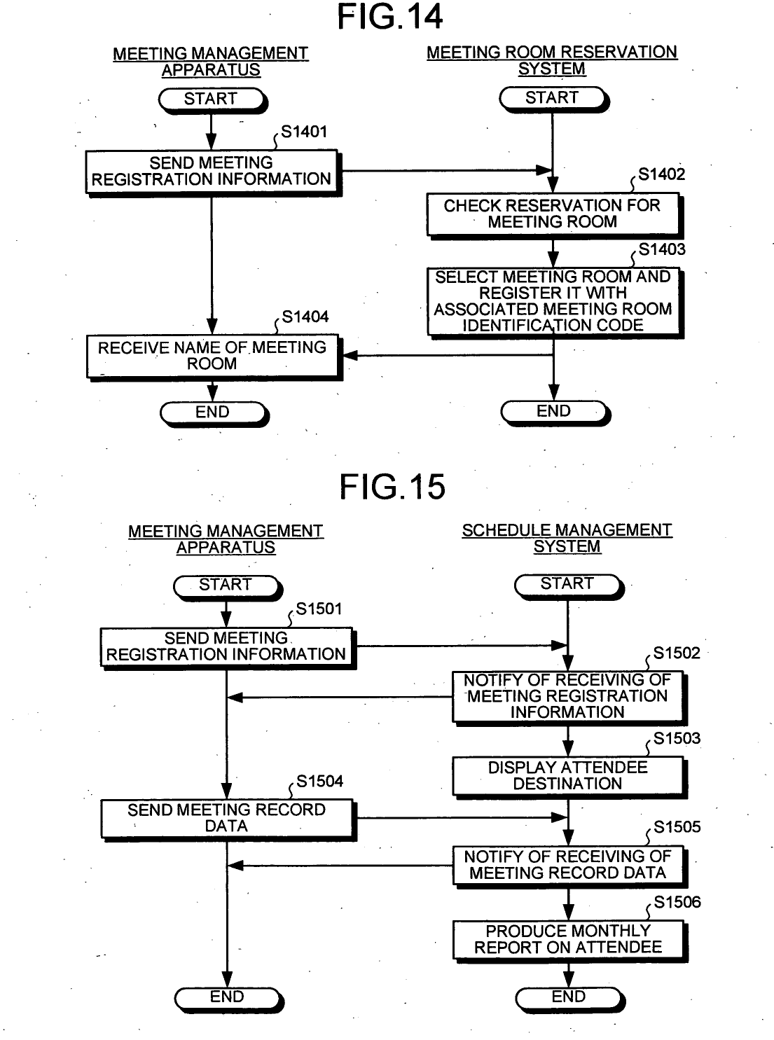

A meeting room reservation process performed by the meeting management system will now be explained while referring to FIG. 14. As illustrated in FIG. 14, the meeting management apparatus 10 sends the meeting registration information to the meeting room reservation system (step S1401). The meeting room reservation system 60 then checks reservations for meeting rooms (step S1402), then selects a meeting room in accordance with the meeting purpose and the number of attendees, and registers it with an associated meeting identification code for reservation (step S1403). When the meeting management apparatus 10 receives the name of the meeting room from the meeting room reservation system 50, it stores the name in the meeting database 20 (step S1404).

Thus, the IF unit 40 sends the meeting reservation information to the meeting room reservation system 60. Therefore, the meeting manager 30 can manage the meeting room reservation system 60 to reserve the meeting rooms for the meetings based on the meeting registration information sent from the IF unit 40.

An attendee schedule management process performed by the meeting management system will now be explained while referring to the flowchart in FIG. 15. Prior to the opening of a meeting, the meeting management apparatus 10 sends the meeting registration information (step S1501). The schedule management system 50 then notifies the meeting management apparatus 10 of receiving of the meeting registration information (step S1502), and displays an attendee destination (step S1503). After the closing of the meeting, the meeting management apparatus 10 sends meeting record data (step S1504). The schedule management system 50 then notifies the meeting management apparatus 10 of receiving of the meeting record data (step S1505), then holds the meeting record data, and reads out the meeting record data, if required, to produce a monthly report on the attendee (step S1506).

Thus, the IF unit 40 sends the meeting reservation information to the schedule management system 50. Therefore, the meeting manager 30 can manage the schedule management system 50 to display the schedules about the attendees based on the meeting registration information sent from the IF unit 40.

Moreover, the IF unit 40 sends the meeting record data to the schedule management system 50. Therefore, the meeting manager 30 can manage the schedule management system 50 to store the meeting record data sent from the IF unit 40.

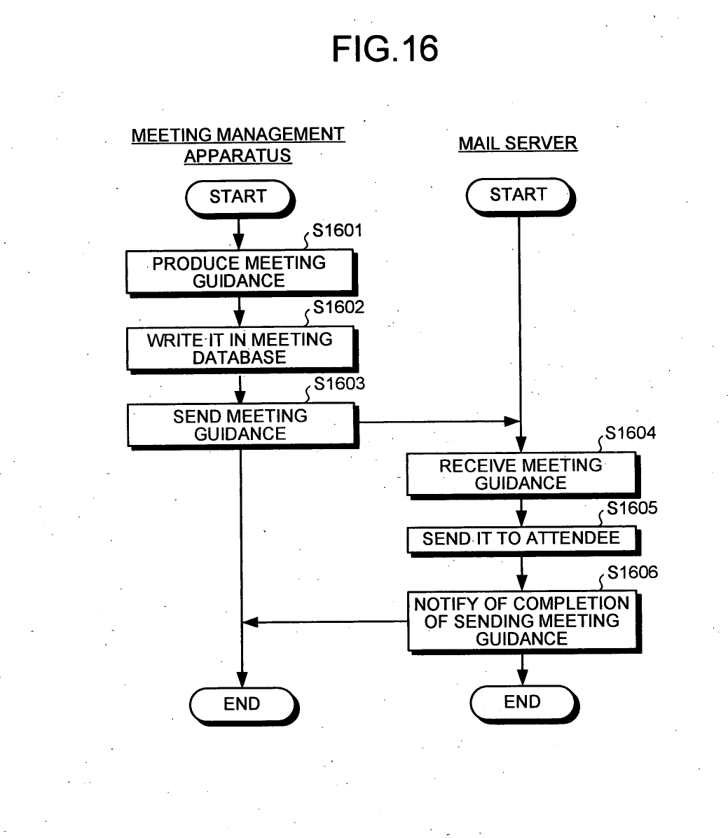

A meeting notification process performed by the meeting management system will now be explained while referring to the flowchart in FIG. 16. As illustrated in FIG. 16, the meeting guidance producer 37 produces a meeting guidance based on the meeting registration information (step S1601) and writes the meeting guidance into the meeting registration information illustrated in FIG. 4 (step S1602). The meeting management apparatus 10 then sends the meeting guidance produced by the meeting guidance producer 37 to the mail server 70 (step S1603). When the mail server 70 receives the meeting guidance from the meeting management apparatus 10 (step S1604), it notifies the attendees of the meeting guidance (step S1605). After notification of the meeting guidance to the attendees, the mail server 70 notifies the meeting management apparatus 10 of completion of sending the meeting guidance (step S1606).

Thus, the IF unit 40 sends the meeting registration information to the meeting mail server 70. Therefore, the meeting manager 30 can manage the mail server 70 to notify the attendees of the meeting guidance based on the meeting registration information sent from the IF unit 40.

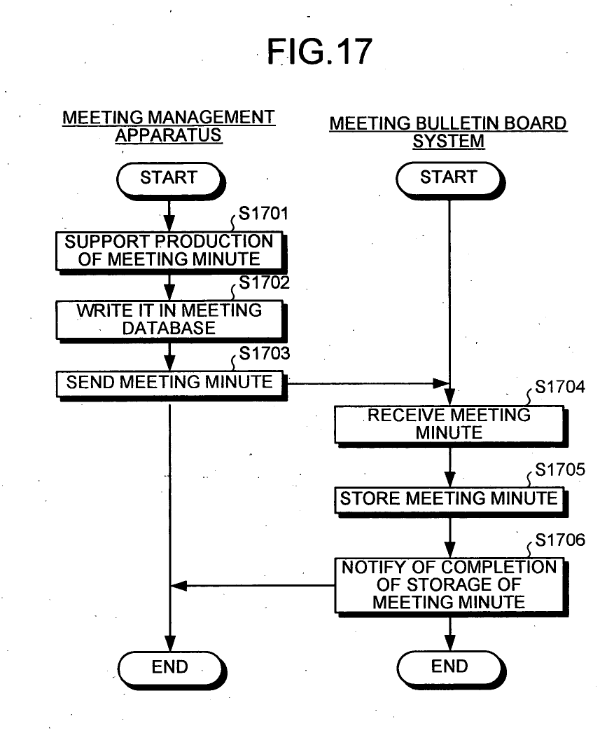

A meeting minute management process performed by the meeting management system will now be explained while referring to the flowchart in FIG. 17. As illustrated in FIG. 17, the meeting minute production supporter 38 supports the user to produce a meeting minute based on the meeting registration information and meeting record data (step S1701). Specifically, it creates a meeting minute template format including meeting titles, dates, locations and attendees described therein based on the meeting registration information and the meeting record information to support the user to produce the meeting minute. It writes the meeting minute produced by the user into the meeting database 20 (step S1702). The meeting management apparatus 10 then sends the meeting minute to the meeting bulletin board system 70 (step S1703). When the meeting bulletin board system 80 receives the meeting minute from the meeting management apparatus 10 (step S1704), it stores the meeting minute (step S1705). After storage of the meeting minute, the meeting bulletin board system 80 notifies the meeting management apparatus 10 of the completion of storage of the meeting minute (step S1706).

Thus, the IF unit 40 sends the minutes of the meetings to the meeting bulletin board system 80. Therefore, the meeting manager 30 can manage the meeting bulletin board system 80 to store the meeting minutes sent from the IF unit 40.

The method of and apparatus for managing meeting according to the first embodiment can be achieved when a previously prepared program is executed in a computer system such as a personal computer and a workstation. A second embodiment of the present invention relates to a computer system that executes a meeting management program having a function similar to the meeting management apparatus described in the first embodiment.

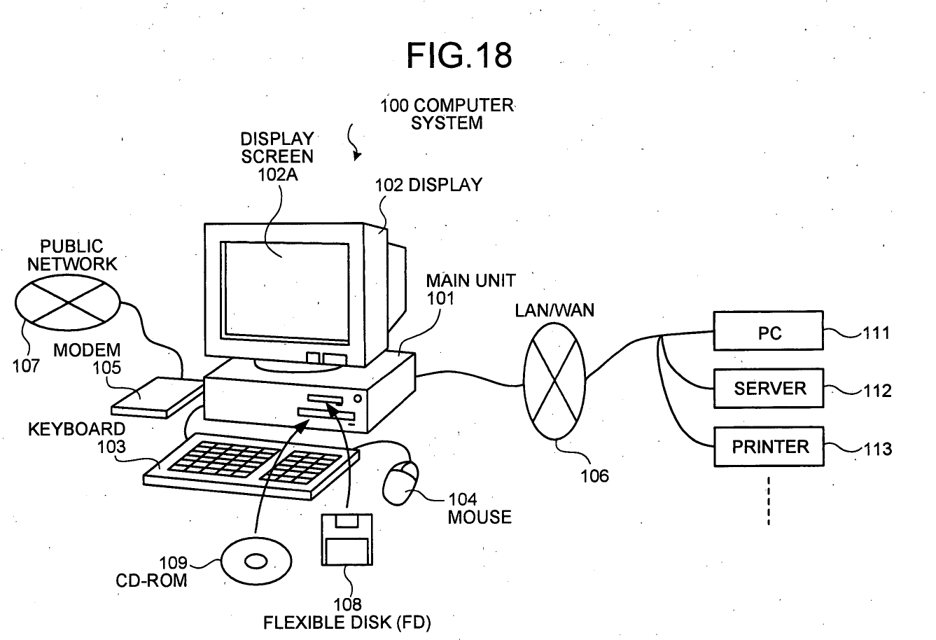

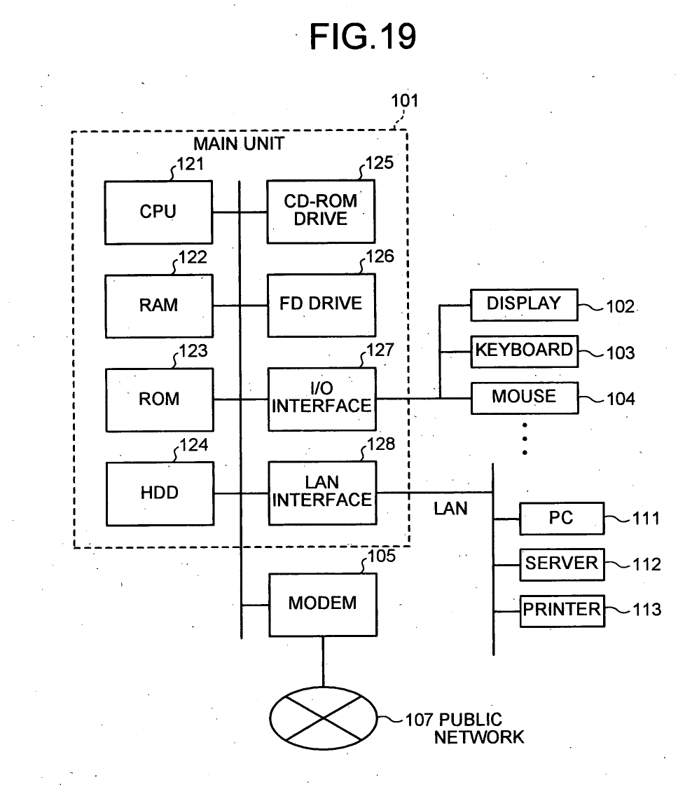

FIG. 18 is a system diagram illustrating a configuration of the computer system according to the second embodiment. FIG. 19 is a block diagram illustrating the main unit in the computer system illustrated in FIG. 18. As illustrated in FIG. 18, the computer system 100 according to the second embodiment includes a main unit 101, a display 102 for displaying information such as images on a display screen 102a based on instructions from the main unit 101, a keyboard 103 for entering various pieces of information into the computer system 100, and a mouse 104 for pointing an arbitrary location on the display screen 102a of the display 102.

As shown in FIG. 19, the main unit 101 of the computer system 100 includes a central processing unit (CPU) 121, a random-access memory (RAM) 122, a read-only memory (ROM) 123, a hard disk drive (HDD) 124, a CD-ROM drive 125 in which a CD-ROM 109 is inserted, an flexible disk (FD) drive 126 in which an FD 108 is inserted, an I/O interface 127 to which the display 102, the keyboard 103, and the mouse 104 are connected, and a local area network (LAN) interface 128 to which a LAN or a wide area network (WAN) 106 are connected.

The computer system 100 is connected to a modem 105 for connection to a public network 107 such as the Internet, and connected, via a LAN interface 128 and a LAN/WAN 106, to other computer system (PC) 111, server 112, and printer 113.

The computer system 100 reads out the meeting management program recorded in a certain recording medium and executes it to achieve a meeting management apparatus. The certain recording medium herein includes any one of recording media that can record the meeting management program in a format readable by the computer system 100, such as: “portable physical media” including an FD 108, a CD-ROM 109, a magneto-optical (MO) disc, a digital versatile disk (DVD), a magneto-optical disc, and an IC card; “fixed physical media” including an HDD 124, a RAM, and a ROM 123 provided inside or outside the computer system 100; and “communications media” including the public network 107 connected via the modem 105, and the LAN interface 128 and the LANNVAN 106 connected to the other computer system 111 and server 112, which hold the program temporarily on transmission of the program.

The meeting management program is computer-readably recorded in the “portable physical media”, the “fixed physical media” and the “communications media”. The computer system 100 achieves the meeting management apparatus and meeting management method when it reads the meeting management program out of such the recording media and executes the program. The execution of the meeting management program is not limited in the computer system 100. The present invention is also applicable to the case in which the other computer system 111 or server 112 executes the meeting management program or they execute the meeting management program cooperatively.

As described above, according to the present invention, it is possible to systematically manage the meetings registered with associated meeting identification codes, it is possible to manage the meetings based on the meeting registration information registered with associated meeting identification codes, it is possible to manage the meetings based on the meeting registration information, and it is possible to manage costs of the meetings based on the meeting costs.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An apparatus for managing meeting information on meetings received from client terminals via a network, comprising:
a meeting manager that manages, upon receipt of the meeting information on meetings from the client terminals, the meetings based on meeting registration information including the meeting information registered with associated meeting identification codes.

2. The apparatus according to claim 1, further comprising a meeting identification code register that registers the meeting information with associated meeting identification codes, wherein
the meeting manager manages the meetings based on the meeting registration information registered with associated meeting identification codes by the meeting identification code register.

3. The apparatus according to claim 1, further comprising a meeting database that stores the meeting registration information including the meeting information on the meetings registered with associated meeting identification codes, wherein
the meeting manager manages the meetings based on the meeting registration information stored in the meeting database.

4. The apparatus according to claim 1, wherein the meeting information includes at least one of a meeting title, an attendee name, a meeting date, and a meeting location.

5. The apparatus according to claim 1, further comprising:
a meeting time recorder that records identification information and entrance/exit times about the attendees in the meetings; and
a meeting database that stores meeting record data on the identification information and entrance/exit times about the attendees recorded by the meeting time recorder and associated with meeting identification codes, and store attendee identification information about the attendees associated with costs per unit time and assigned organizations, wherein
the meeting manager manages the meetings based on the meeting record data and the attendee identification information stored in the meeting database.

6. The apparatus according to claim 1, further comprising a meeting cost calculator that calculates meeting costs based on the entrance/exit times and the costs per unit time about the attendees in the meetings, wherein
the meeting manager manages costs of the meetings based on the meeting costs calculated by the meeting cost calculator.

7. The apparatus according to claim 6, wherein the meeting cost calculator calculates meeting costs by person, meeting, and organization.

8. The apparatus according to claim 1, further comprising a meeting reservation information sender that sends the meeting reservation information to a meeting room reservation system that manages a schedule for utilization of meeting rooms for the meetings, wherein
the meeting manager manages the meeting room reservation system to reserve the meeting rooms for the meetings based on the meeting registration information sent from the meeting reservation information sender.

9. The apparatus according to claim 1, further comprising a meeting reservation information sender that sends the meeting reservation information to a schedule management system that manages schedules about the attendees, wherein
the meeting manager manages the schedule management system to display the schedules about the attendees based on the meeting registration information sent from the meeting reservation information sender.

10. The apparatus according to claim 5, further comprising a meeting record data sender that sends meeting record data to a schedule management system that manages schedules about the attendees, wherein
the meeting manager manages the schedule management system to store the meeting record data sent from the meeting record data sender.

11. The apparatus according to claim 1, further comprising a meeting registration information sender that sends the meeting registration information to a meeting mail server that notifies the attendees in the meeting of a meeting guidance, wherein
the meeting manager manages the mail server to notify the attendees of the meeting guidance based on the meeting registration information sent from the meeting registration information sender.

12. The apparatus according to claim 1, further comprising a meeting minute sender that sends minutes of the meetings to a meeting bulletin board system that stores the minutes of the meetings, wherein
the meeting manager manages the meeting bulletin board system to store the meeting minutes sent from the meeting minute sender.

13. A computer program for executing management of meeting information on meetings received from client terminals via a network, the computer program making a computer execute:
managing, upon receipt of the meeting information on meetings from the client terminals, the meetings based on meeting registration information including the meeting information registered with associated meeting identification codes.

14. The computer program according to claim 13, further making the computer execute registering the meeting information with associated meeting identification codes, wherein
the managing includes managing the meetings based on the meeting registration information registered with associated meeting identification codes by the meeting identification code register.

15. The computer program according to claim 13, further making the computer execute storing in a meeting database the meeting registration information including the meeting information on the meetings registered with associated meeting identification codes, wherein
the managing includes managing the meetings based on the meeting registration information stored in the meeting database.

16. The computer program according to claim 13, wherein the meeting information includes at least one of a meeting title, an attendee name, a meeting date, and a meeting location.

17. The computer program according to claim 13, further making the computer execute:
recording identification information and entrance/exit times about the attendees in the meetings; and
producing a meeting database that stores meeting record data on the identification information and entrance/exit times about the attendees recorded by the meeting time recorder and associated with meeting identification codes, and storing attendee identification information about the attendees associated with costs per unit time and assigned organizations, wherein
the managing includes managing the meetings based on the meeting record data and the attendee identification information stored in the meeting database.

18. The computer program according to claim 13, further making the computer execute calculating meeting costs based on entrance/exit times and a costs per unit time about attendees of the meetings, wherein
the managing includes managing costs of the meetings based on the meeting costs calculated by the meeting cost calculator.

19. The computer program according to claim 18, wherein the calculating includes calculating meeting costs by person, meeting, and organization.

20. A method of managing meeting information on meetings received from client terminals via a network, comprising:
managing, upon receipt of the meeting information on meetings from the client terminals, the meetings based on meeting registration information including the meeting information registered with associated meeting identification codes.

21. The method according to claim 20, further comprising registering the meeting information with associated meeting identification codes, wherein
the managing includes managing the meetings based on the meeting registration information registered with associated meeting identification codes by the meeting identification code register.
